(19) United States
(12) Patent Application Publication
(10) Pub. No.: US 2016/0286044 A1
(43) Pub. Date: Sep. 29, 2016

(54) Terminal and Recording Method of Terminal

(71) Applicant: Huawei Technologies Co., Ltd., Shenzhen (CN)

(72) Inventors: Jiake Wang, Shenzhen (CN); Mingyu Zhang, Shenzhen (CN)

(21) Appl. No.: 15/172,763

(22) Filed: Jun. 3, 2016

Related U.S. Application Data
(63) Continuation of application No. PCT/CN2014/081716, filed on Jul. 7, 2014.

(30) Foreign Application Priority Data
Dec. 3, 2013 (CN) 201310642114.1

(51) Int. Cl. H04M 3/42

(52) U.S. Cl. CPC H04M 3/42221

(57) ABSTRACT

A terminal and a recording method of the terminal are presented. The terminal includes one or more processors and a memory storing computer readable program, where the one or more processors is configured to monitor call trigger event, and when the call trigger event is detected, trigger the call unit to switch a terminal status; control switching of the terminal status; and initiate a recording operation to start recording of the current call when the terminal status controlled by the call unit is switched to the calling state related to the call trigger event. If a call is performed with the terminal and recording is needed, a recording operation is automatically initiated according to a one-off event trigger and monitoring of the terminal status, which simplifies steps of the recording operation of the terminal, improves usability of the terminal, and achieves a one-click effect of recording and calling.

### CROSS-REFERENCE TO RELATED APPLICATIONS

This application is a continuation of International Application No. PCT/CN2014/081716, filed on Jul. 7, 2014, which claims priority to Chinese Patent Application No. 201310642114.1, filed on Dec. 3, 2013, both of which are hereby incorporated by reference in their entireties.

### TECHNICAL FIELD

The present disclosure relates to the field of communications technologies, and in particular, to a terminal and a recording method of the terminal.

### BACKGROUND

Circuit recording functions of various terminals, for example, a mobile phone, are more frequently used and become more important in daily lives. In an existing recording technology, a call recording function is implemented using recording software that runs independently. After a call is connected, a user may choose to record the current call. However, the user needs to perform two operations, that is, calling and recording, to achieve an objective, which is not simple enough. A recording policy may also be set in advance. After the call is connected for the user, recording is performed according to a specific policy. However in this case, the policy cannot be dynamically adjusted, which is not flexible or practical enough. In another recording technology, whether to perform recording is controlled using an external button or a sensor, which increases a recording cost, and does not simplify operations as two operations are required to achieve the objective.

### SUMMARY

Embodiments of the present disclosure provide a terminal and a recording method of the terminal, where if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

According to a first aspect, a terminal is provided, including a trigger unit, a call unit, and a recording unit, where the trigger unit is configured to monitor a call trigger event, and when the call trigger event is found, trigger the call unit to switch a terminal status, where the terminal status includes a calling state related to the call trigger event, the calling state indicates that a current call is in progress, and the call trigger event is used to indicate either of the following two situations: calling and recording, and answering and recording; the call unit is configured to control switching of the terminal status; and the recording unit is configured to, when the terminal status controlled by the call unit is switched to the calling state related to the call trigger event, initiate a recording operation to start recording of the current call.

In a first possible implementation manner, the call unit is configured to, when the terminal status is controlled to be switched to the calling state related to the call trigger event, send, to the recording unit, information used to indicate that the terminal status is the calling state related to the call trigger event; and the recording unit is configured to receive the information used to indicate that the terminal status is the calling state related to the call trigger event, determine, according to the information, that the terminal status controlled by the call unit is switched to the calling state related to the call trigger event, and initiate the recording operation.

With reference to the first aspect, in a second possible implementation manner, the call unit is configured to, when the terminal status is controlled to be switched to the calling state related to the call trigger event, send a recording operation instruction to the recording unit; and the recording unit is configured to receive the recording operation instruction, and initiate the recording operation according to the recording operation instruction.

With reference to the first aspect, in a third possible implementation manner, the trigger unit is further configured to, when the call trigger event is found, trigger the recording unit to detect the terminal status controlled by the call unit; and the recording unit is configured to, when detecting that the terminal status is the calling state related to the call trigger event, initiate the recording operation.

With reference to the first aspect, in a fourth possible implementation manner, the recording unit is configured to periodically detect the terminal status controlled by the call unit, and when detecting that the terminal status is the calling state related to the call trigger event, initiate the recording operation.

With reference to the first aspect, in a fifth possible implementation manner, the trigger unit is further configured to learn, in any one of the following manners, that the terminal status is the calling state related to the call trigger event, when the call trigger event is found, starting to detect the terminal status; and receiving information that is sent by the call unit and that is used to indicate that the terminal status is the calling state related to the call trigger event; and the trigger unit is further configured to, when learning that the terminal status is the calling state related to the call trigger event, trigger the recording unit to initiate the recording operation.

With reference to the first aspect, or the first possible implementation manner of the first aspect, or the second possible implementation manner of the first aspect, or the third possible implementation manner of the first aspect, or the fourth possible implementation manner of the first aspect, or the fifth possible implementation manner of the first aspect, in a sixth possible implementation manner, the recording unit is further configured to acquire an identifier of a peer end of the current call, create a recording file with a character string including the identifier as a file name, and record content of the current call in the recording file.

According to a second aspect, a recording method of a terminal is provided, including listening to a call trigger event, where the call trigger event is used to indicate either of the following two situations: calling and recording, and answering and recording; when the call trigger event is found, starting control of switching of a terminal status, where the terminal status includes a calling state related to the call trigger event, and the calling state indicates that a current call is in progress; and when the terminal status is switched to the calling state related to the call trigger event, initiating a recording operation to start recording of the current call.

In a first possible implementation manner, when the terminal status is switched to the calling state related to the call trigger event, the method includes periodically detecting the terminal status, and when it is detected for the first time that the terminal status is the calling state related to the call trigger event, determining that the terminal status is switched to the calling state related to the call trigger event.

With reference to the second aspect, in a second possible implementation manner, when the terminal status is switched to the calling state related to the call trigger event, the method includes, when a notification indicating that the terminal status is the calling state related to the call trigger event is received, determining that the terminal status is switched to the calling state related to the call trigger event.

It can be learned that in the technical solutions in which the terminal and the recording method of the terminal that are provided in the embodiments of the present disclosure are used, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and persons of ordinary skill in the art may still derive other drawings from these accompanying drawings without creative efforts.

FIG. 1 is a schematic structural diagram of a terminal according to an embodiment of the present disclosure;

FIG. 2A is a schematic diagram of an interface of a call dial pad of a terminal according to an embodiment of the present disclosure;

FIG. 2B is a schematic diagram of an interface of a call answering pad of a terminal according to an embodiment of the present disclosure;

FIG. 3 is a schematic diagram of interaction between internal modules of a terminal according to an embodiment of the present disclosure;

FIG. 4 is another schematic diagram of interaction between internal modules of a terminal according to an embodiment of the present disclosure;

FIG. 5 is still another schematic diagram of interaction between internal modules of a terminal according to an embodiment of the present disclosure;

FIG. 6 is yet another schematic diagram of interaction between internal modules of a terminal according to an embodiment of the present disclosure;

FIG. 7 is still yet another schematic diagram of interaction between internal modules of a terminal according to an embodiment of the present disclosure;

FIG. 8 is a schematic flowchart of a recording method of a terminal according to an embodiment of the present disclosure; and

FIG. 9 is another schematic structural diagram of a terminal according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

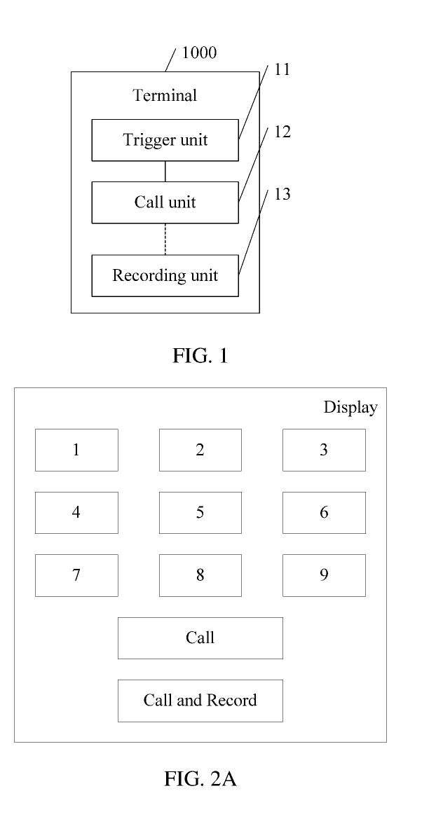

Referring to FIG. 1, FIG. 1 is a schematic structural diagram of a terminal according to an embodiment of the present disclosure. As shown in FIG. 1, the terminal 1000 includes a trigger unit 11, a call unit 12, and a recording unit 13. When the trigger unit 11 finds a call trigger event, the call unit 12 and the recording unit 13 respectively perform a call operation and a recording operation. The call trigger event is used to indicate either of the following two situations: calling and recording, and answering and recording.

The trigger unit 11 is configured to monitor a call trigger event, and when the call trigger event is found, trigger the call unit 12 to switch a terminal status, where the terminal status includes a calling state related to the call trigger event, the calling state indicates that a current call is in progress, and the call trigger event is used to indicate either of the following two situations: calling and recording, and answering and recording.

The trigger unit 11 may be a sensor in the terminal, a key detection module in the terminal, or the like.

The terminal in this embodiment of the present disclosure refers to an electronic device that may perform voice communication with another terminal and has a recording function, for example, a mobile phone, a tablet computer, a laptop, or a desktop computer.

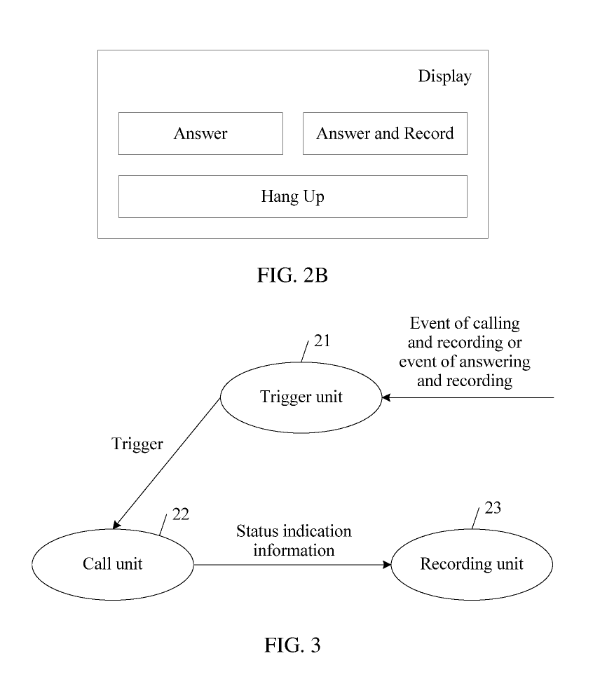

As shown in FIG. 2A, FIG. 2A is a schematic diagram of an interface of a call dial pad of a terminal according to an embodiment of the present disclosure. Compared with the prior art, a “call and record” key is added to the dial interface, and other keys remain unchanged. Optionally, as shown in FIG. 2B, FIG. 2B is a schematic diagram of an interface of a call answering pad of a terminal according to an embodiment of the present disclosure. Compared with the prior art, an “answer and record” key is added to the called interface of an incoming call, and other keys remain unchanged. Either one or both of the “call and record” key and the “answer and record” key may be added.

It should be noted that the names of the keys key name is only described as an example, and this embodiment of the present disclosure sets no limitation on the key name. The “key” in this embodiment of the present disclosure may be a physical key, or a virtual key on a touchscreen, or a key in another form. This embodiment of the present disclosure sets no limitation thereto.

When the terminal is used for a call, the trigger unit 11 listens to the call trigger event, where the call trigger event may be a key event. For example, it is found that a user presses the “call and record” key in FIG. 2A or the “answer and record” key in FIG. 2B. When the trigger unit 11 finds the call trigger event, the call unit 12 is triggered to switch the terminal status, where the terminal status includes the calling state related to the call trigger event, and the calling state indicates that the current call is in progress. In this embodiment of the present disclosure, the terminal status may further include a calling state of another type, for example, a calling state triggered by a “call” key and related to the call event. Calling states triggered by different events (keys) are set to be different (for example, different state identifiers are set), so as to determine whether the recording operation should be initiated for the current call.

The call unit 12 is configured to control switching of the terminal status.

The recording unit 13 is configured to, when the terminal status controlled by the call unit 12 is switched to the calling state related to the call trigger event, initiate the recording operation to start recording of the current call.

When the terminal status controlled by the call unit 12 is switched to the calling state related to the call trigger event, the recording unit 13 initiates the recording operation to start recording of the current call. That is, when the trigger unit 11 finds the call trigger event, the recording unit 13 performs recording according to the terminal status switched by the call unit 12 in real time.

The following exemplarily describes, using two application scenarios, the switching of the terminal status and a process of automatic recording in this embodiment of the present disclosure.

1. Calling: The terminal status is initially an idle state, that is, a state in which no activity related to a call is carried out. When intending to use the terminal provided in this embodiment of the present disclosure to call another person and intending to perform recording on a possible call, the user only needs to press the “call and record” key shown in FIG. 2A. After finding the event, the trigger unit 11 triggers the call unit 12 to switch the terminal status. The idle state is switched to a state of waiting for answering of the other party, and after the other party successfully answers the call, the waiting state is switched to a calling state corresponding to the event. Once the recording unit learns that the terminal status is switched to the calling state, recording may be initiated to start recording of the current call.

2. Answering: The terminal status is initially a state of waiting for answering, that is, a call is incoming and waits to be answered by the user of the terminal. When intending to use the terminal provided in this embodiment of the present disclosure to answer the incoming call and perform recording on the current call, the user only needs to press the “answer and record” key shown in FIG. 2B. After finding the event, the trigger unit 11 triggers the call unit 12 to switch the terminal status. The state of waiting for answering is switched to a calling state corresponding to the event. Once the recording unit learns that the terminal status is switched to the calling state, recording may be initiated to start recording of the current call.

It should be noted that the calling states triggered in the foregoing two scenarios are set to have a same identifier, or may be set to have different identifiers. However, if the terminal has a calling state triggered by another event, for example, a calling state triggered by pressing the “call” key shown in FIG. 2A or the “answer” key shown in FIG. 2B, the calling state needs to be distinguished from the calling states triggered in the foregoing two scenarios. For example, a different identifier is added, or different identifiers are used to represent different calling states, so as to distinguish whether the recording needs to be automatically initiated.

When the terminal status is switched from the calling state corresponding to the call trigger event in this embodiment of the present disclosure to another state, the recording unit 13 stops the recording operation. For example, after the call is hung up, the terminal status is switched from the calling state to the idle state. In this case, the recording unit 13 automatically stops recording. In another embodiment, the recording unit 13 may further monitor an event, and suspends or stops recording when finding an event used to indicate a pause or a stop. For example, when the user is on the call and recording is performed on the current call, an interface of the terminal in this embodiment of the present disclosure presents a key of “pause” or “stop” of recording to the user, and the user triggers, by pressing the key, the recording unit to suspend or stop recording. Certainly, the two keys may also exist at the same time.

It can be learned that according to the terminal provided in this embodiment of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

Referring to FIG. 3, FIG. 3 is a schematic diagram of interaction between internal modules of a terminal according to an embodiment of the present disclosure. As shown in FIG. 3, a trigger unit 21 is configured to monitor a call trigger event, and when the call trigger event is found, trigger a call unit 22 to switch a terminal status, where the terminal status includes a calling state related to the call trigger event, the calling state indicates that a current call is in progress, and the call trigger event is used to indicate either of the following two situations: calling and recording, and answering and recording.

For example, when the terminal is used for a call, four types of trigger events may be found, correspond to a call dial pad shown in FIG. 2A and a call answering pad shown in FIG. 2B, and correspond to four key events: a calling event where only the call is performed, and no recording is performed; an event of calling and recording where the call is performed, and recording is performed on a possible call; an answering event where only answering is performed, and no recording is performed; an event of answering and recording where answering is performed, and recording is performed on the current call.

The trigger unit 21 may trigger, only when finding the event of calling and recording or the event of answering and recording, the call unit 22 to switch the terminal status, and may also trigger, when finding any event of the foregoing four key events, the call unit 22 to switch the terminal status. However, recording is started only when the terminal status is the calling state related to the call trigger event defined in this embodiment of the present disclosure.

The call unit 22 is configured to, when the terminal status is controlled to be switched to the calling state related to the call trigger event, send, to a recording unit 23, information used to indicate that the terminal status is the calling state related to the call trigger event.

When finding the call trigger event, the trigger unit 21 sends a calling or call connection request to the call unit 22. In this case, the call unit 22 establishes a calling or call connection, and the calling state also changes. For example, before the call trigger event occurs, the calling state may be an idle state. After the terminal status is triggered by the trigger unit 21 to be switched, the calling state is switched to a state of waiting for answering of the other party, and is switched to the calling state again after the other party answers the call. The calling state is the calling state related to the call trigger event.

The recording unit 23 is configured to receive the information used to indicate that the terminal status is the calling state related to the call trigger event, determine, according to the information, that the terminal status controlled by the call unit 22 is switched to the calling state related to the call trigger event, and initiate a recording operation.

When receiving the information used to indicate that the terminal status is the calling state related to the call trigger event, the recording unit 23 determines, according to the information, that the call trigger events defined in this embodiment of the present disclosure occurs, and that the current call is in progress. Therefore, the recording operation is initiated to start recording of the current call.

The recording unit 23 is further configured to acquire an identifier of a peer end of the current call, create a recording file with a character string including the identifier as a file name, and record content of the current call in the recording file.

When starting the recording, the recording unit 23 may create the recording file to record the content of the current call. The name of the recording file may be directly set to the identifier of the peer end of the current call (for example, a mobile phone number of the other party), or may be a character string including the identifier and another character. In short, it is appropriate that by means of the name of the recording file, a person for whom the recording file of the call is may be distinguished. If the mobile phone number of the other party cannot be acquired, a default character string beforehand is used instead, for example, record n, where n indicates the n^{th} recording file.

The recording unit 23 may acquire the identifier of the peer end of the current call from the call unit 22, and when the call unit 22 sends, to the recording unit, the information used to indicate that the terminal status is the calling state related to the call trigger event, the information may include the identifier. Certainly, the recording unit 23 may also acquire the identifier of the peer end of the current call in another manner. Because a display of the identifier of the peer end can already be implemented in the prior art, the recording unit 23 may acquire the identifier of the peer end using any means corresponding to the prior art. Details are not described in this embodiment of the present disclosure.

It can be learned that according to the terminal provided in this embodiment of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

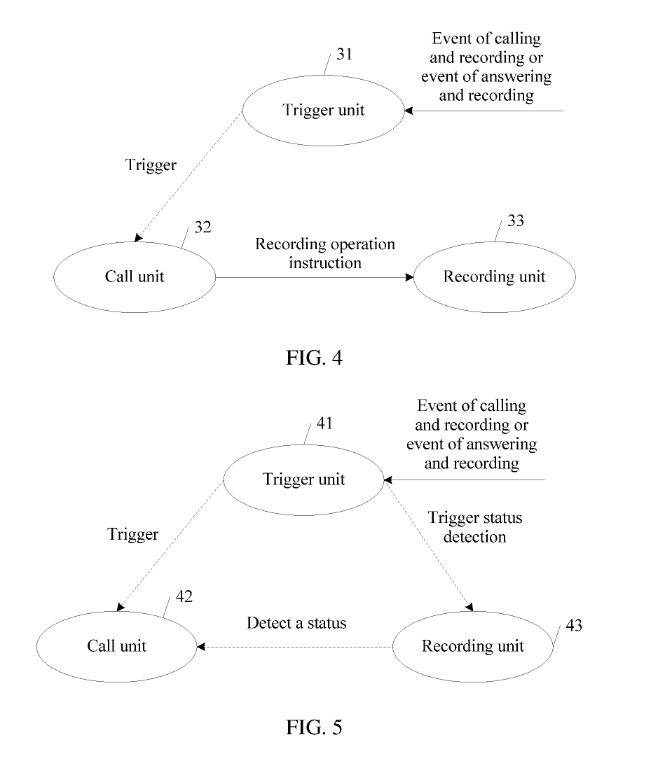

Referring to FIG. 4, FIG. 4 is another schematic diagram of interaction between internal modules of a terminal according to an embodiment of the present disclosure. As shown in FIG. 4, a trigger unit 31 is configured to monitor a call trigger event, and when the call trigger event is found, trigger a call unit 32 to switch a terminal status, where the terminal status includes a calling state related to the call trigger event, the calling state indicates that a current call is in progress, and the call trigger event is used to indicate either of the following two situations: calling and recording, and answering and recording.

A function of the trigger unit 31 is the same as those of the trigger unit 11 and the trigger unit 21 in the foregoing embodiments, and details are not described herein again.

The call unit 32 is configured to, when the terminal status is controlled to be switched to the calling state related to the call trigger event, send a recording operation instruction to a recording unit 33.

A difference between this embodiment and the foregoing embodiments is that when the terminal status is controlled to be switched to the calling state related to the call trigger event, the call unit 32 directly sends the recording operation instruction to the recording unit 33, that is, the recording unit does not need to learn the terminal status.

The recording unit 33 is configured to receive the recording operation instruction, and initiate a recording operation according to the recording operation instruction.

Further, the recording unit 33 is further configured to acquire an identifier of a peer end of the current call, create a recording file with a character string including the identifier as a file name, and record content of the current call in the recording file. For details about creation of the recording file, refer to description in the foregoing embodiment, and details are not described herein again.

It can be learned that according to the terminal provided in this embodiment of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

Referring to FIG. 5, FIG. 5 is still another schematic diagram of interaction between internal modules of a terminal according to an embodiment of the present disclosure. As shown in FIG. 5, a trigger unit 41 is configured to monitor a call trigger event, and when the call trigger event is found, trigger a call unit 42 to switch a terminal status, where the terminal status includes a calling state related to the call trigger event, the calling state indicates that a current call is in progress, and the call trigger event is used to indicate either of the following two situations: calling and recording, and answering and recording.

The trigger unit 41 is further configured to, when the call trigger event is found, trigger a recording unit 43 to detect the terminal status controlled by the call unit 42.

A difference between the trigger unit 41 in this embodiment and a trigger unit in the foregoing embodiment is that when the call trigger event is found, the trigger unit 41 further triggers the recording unit 43 to detect the terminal status controlled by the call unit 42.

The call unit 42 is configured to control switching of the terminal status.

A function of the call unit 42 is the same as that of the call unit 12 in the foregoing embodiment, and details are not described herein again.

The recording unit 43 is configured to, when detecting that the terminal status is the calling state related to the call trigger event, initiate a recording operation.

After being triggered by the trigger unit 41, the recording unit 43 starts to detect the terminal status controlled by the call unit 42, and when detecting that the terminal status is the calling state related to the call trigger event defined in this embodiment of the present disclosure, initiates the recording operation.

Further, the recording unit 43 is further configured to acquire an identifier of a peer end of the current call, create a recording file with a character string including the identifier as a file name, and record content of the current call in the recording file. For details about creation of the recording file, refer to description in the foregoing embodiment, and details are not described herein again.

It can be learned that according to the terminal provided in this embodiment of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

Referring to FIG. 6, FIG. 6 is yet another schematic diagram of interaction between internal modules of a terminal according to an embodiment of the present disclosure. As shown in FIG. 6, a trigger unit 51 is configured to monitor a call trigger event, and when the call trigger event is found, trigger a call unit 52 to switch a terminal status, where the terminal status includes a calling state related to the call trigger event, the calling state indicates that a current call is in progress, and the call trigger event is used to indicate either of the following two situations: calling and recording, and answering and recording.

The call unit 52 is configured to control switching of the terminal status.

Functions of the trigger unit 51 and the call unit 52 in this embodiment are respectively the same as those of the trigger unit 11 and the call unit 12 in the foregoing embodiment, and details are not described herein again.

A recording unit 53 is configured to periodically detect the terminal status controlled by the call unit 52, and when detecting that the terminal status is the calling state related to the call trigger event, initiate a recording operation.

In this embodiment, the recording unit 53 actively and periodically detects the terminal status controlled by the call unit 52, and when detecting that the terminal status is the calling state related to the call trigger event defined in this embodiment of the present disclosure, initiates the recording operation.

Further, the recording unit 43 is further configured to acquire an identifier of a peer end of the current call, create a recording file with a character string including the identifier as a file name, and record content of the current call in the recording file. For details about creation of the recording file, refer to description in the foregoing embodiment, and details are not described herein again.

It can be learned that according to the terminal provided in this embodiment of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

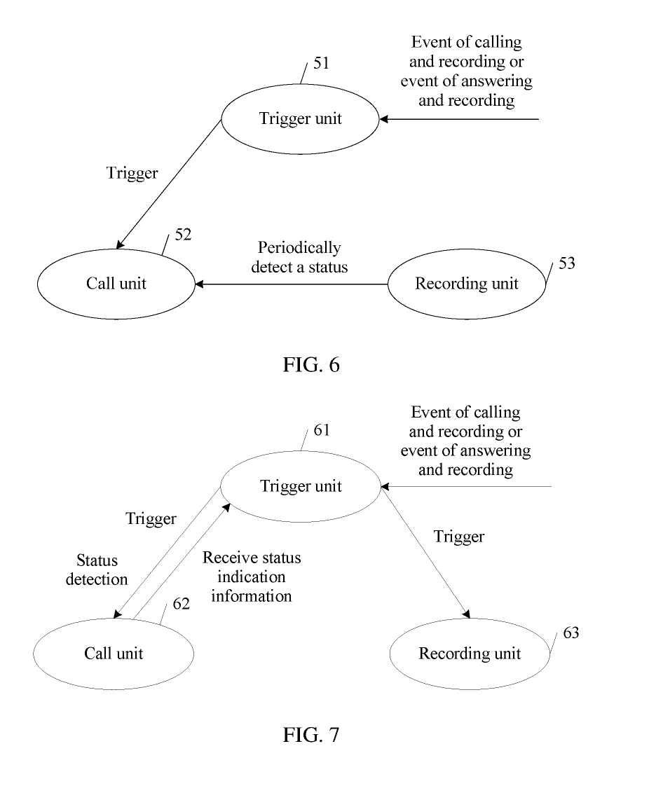

Referring to FIG. 7, FIG. 7 is still yet another schematic diagram of interaction between internal modules of a terminal according to an embodiment of the present disclosure. As shown in FIG. 7, a trigger unit 61 is configured to monitor a call trigger event, and when the call trigger event is found, trigger a call unit 62 to switch a terminal status, where the terminal status includes a calling state related to the call trigger event, the calling state indicates that a current call is in progress, and the call trigger event is used to indicate either of the following two situations: calling and recording, and answering and recording.

The trigger unit 61 is further configured to learn, in any one of the following manners, that the terminal status is the calling state related to the call trigger event.

In an implementation manner, when the call trigger event is found, the trigger unit 61 starts to detect the terminal status controlled by the call unit 62.

In another implementation manner, the trigger unit 61 receives information that is sent by the call unit 62 and that is used to indicate that the terminal status is the calling state related to the call trigger event.

The trigger unit 61 in this embodiment may actively monitor switching of the terminal status controlled by the call unit 62, and may also receive the information that is sent by the call unit 62 and that is used to indicate that the terminal status is the calling state related to the call trigger event defined in this embodiment of the present disclosure. The two manners of acquiring the terminal status may exist at the same time, or only one manner thereof may exist.

The trigger unit 61 is further configured to, when learning that the terminal status is the calling state related to the call trigger event, trigger a recording unit 63 to initiate a recording operation.

The call unit 62 is configured to control switching of the terminal status.

The recording unit 63 is configured to, when the terminal status controlled by the call unit 62 is switched to the calling state related to the call trigger event, initiate the recording operation to start recording of the current call.

Further, the recording unit 63 is further configured to acquire an identifier of a peer end of the current call, create a recording file with a character string including the identifier as a file name, and record content of the current call in the recording file. For details about creation of the recording file, refer to description in the foregoing embodiment, and details are not described herein again.

It can be learned that according to the terminal provided in this embodiment of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

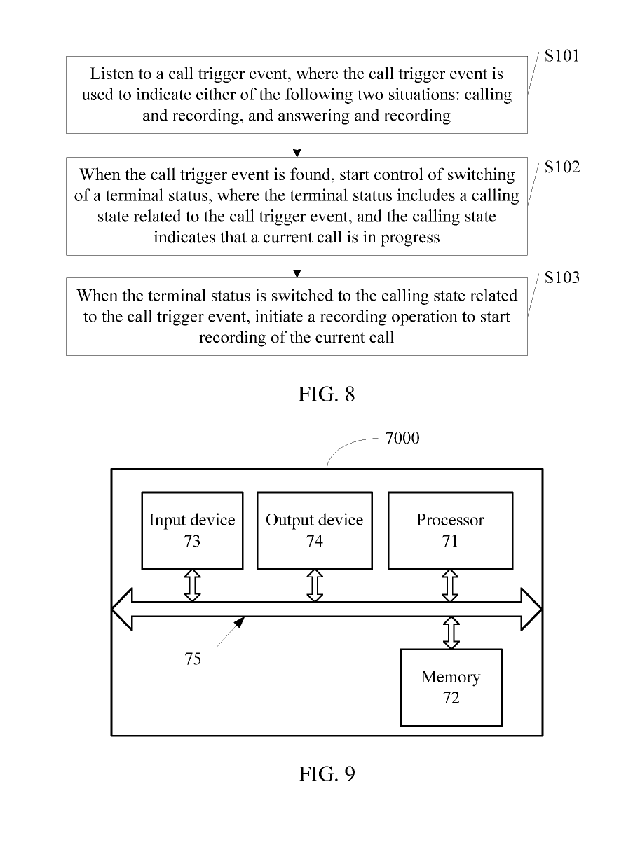

Referring to FIG. 8, FIG. 8 is a schematic flowchart of a recording method of a terminal according to an embodiment of the present disclosure. As shown in FIG. 8, the method includes the following steps.

Step S101: Monitor a call trigger event, where the call trigger event is used to indicate either of the following two situations: calling and recording, and answering and recording.

The terminal in this embodiment of the present disclosure refers to an electronic device that may perform voice communication with another terminal and has a recording function, for example, a mobile phone. As shown in FIG. 2A, FIG. 2A is a schematic diagram of an interface of a call dial pad of a terminal according to an embodiment of the present disclosure. Compared with the prior art, a “call and record” key is added to the dial interface, and other keys remain unchanged. As shown in FIG. 2B, FIG. 2B is a schematic diagram of an interface of a call answering pad of a terminal according to an embodiment of the present disclosure. Compared with the prior art, an “answer and record” key is added to the called interface of an incoming call, and other keys remain unchanged.

Step S102: When the call trigger event is found, start control of switching of a terminal status, where the terminal status includes a calling state related to the call trigger event, and the calling state indicates that a current call is in progress.

When the call trigger event is found, the terminal status also changes. For example, before the call trigger event occurs, the terminal status may be an idle state or a state of waiting for answering. After the call trigger event is found or the call is successfully connected, the terminal status is switched to a state in which the current call is in progress.

Step S103: When the terminal status is switched to the calling state related to the call trigger event, initiate a recording operation to start recording of the current call.

When the controlled terminal status is switched to the calling state related to the call trigger event, the recording operation is initiated to start recording of the current call, that is, when the call trigger event is found, the recording is automatically started according to the terminal status switched in real time.

As an implementation manner, when the terminal status is switched to the calling state related to the call trigger event, the method includes periodically detecting the terminal status, and when it is detected for the first time that the terminal status is the calling state related to the call trigger event, determining that the terminal status is switched to the calling state related to the call trigger event.

As another implementation manner, when the terminal status is switched to the calling state related to the call trigger event, the method includes, when a notification indicating that the terminal status is the calling state related to the call trigger event is received, determining that the terminal status is switched to the calling state related to the call trigger event. The “notification” is a message between internal modules of the terminal. For a specific implementation manner, reference may be made to the foregoing apparatus embodiment.

A user uses the terminal provided in this embodiment of the present disclosure for a call. When preparing for the call, the user only needs to press, for example, the “call and record” key in FIG. 2A or the “answer and record” key in FIG. 2B. Starting or stopping of subsequent recording is completely controlled by the terminal, and the user does not need to perform a second operation.

It can be learned that according to the recording method of the terminal provided in this embodiment of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

Referring to FIG. 9, FIG. 9 is another schematic structural diagram of a terminal according to an embodiment of the present disclosure. A terminal 7000 in this embodiment includes a processor 71, a memory 72, an input device 73, an output device 74, and a bus system 75.

The processor 71 controls an operation of the terminal 7000, and the processor 71 may also be referred to as a central processing unit (CPU). The processor 71 may be an integrated circuit chip and has a signal processing capability. The processor 71 may also be a general purpose processor, a digital signal processor (DSP), an application-specific integrated circuit (ASIC), a field programmable gate array (FPGA), or another programmable logical device, discrete gate or transistor logical device, or discrete hardware component. The general purpose processor may be a microprocessor or the processor may be any conventional processor and the like.

The memory 72 may include a read-only memory and a random access memory, and provides an instruction and data to the processor 71. A part of the memory 72 may further include a non-volatile random access memory (NVRAM).

Various components of the terminal 7000 are coupled using the bus system 75, where the bus may be an industry standard architecture (ISA) bus, a peripheral component interconnect (PCI) bus, an extended industry standard architecture (EISA) bus, or the like. The bus may be one or more physical lines, and when the bus is multiple physical lines, the bus may be divided into an address bus, a data bus, a control bus, and the like. In some other embodiments of the present disclosure, the processor 71, the memory 72, the input device 73, and the output device 74 may also be directly connected using a communications line.

The input device 73 may be implemented as a mouse, a keyboard, a microphone, or the like. The output device 74 may be implemented as a display, an audio device, or a video device. Certainly, functions of the input device 73 and the output device 74 may also be implemented using an input/output device, for example, the input device 73 and the output device 74 are implemented as a touchable screen.

The processor 71 reads a computer program in the memory 72 to execute the following steps: listening to a call trigger event, where the call trigger event is used to indicate either of the following two situations: calling and recording, and answering and recording; when the call trigger event is found, starting control of switching of a terminal status, where the terminal status includes a calling state related to the call trigger event, and the calling state indicates that a current call is in progress; and when the terminal status is switched to the calling state related to the call trigger event, initiating a recording operation to start recording of the current call.

As an implementation manner, the step executed by the processor 71 when the terminal status is switched to the calling state related to the call trigger event includes periodically detecting the terminal status, and when it is detected for the first time that the terminal status is the calling state related to the call trigger event, determining that the terminal status is switched to the calling state related to the call trigger event.

As another implementation manner, the step executed by the processor 71 when the terminal status is switched to the calling state related to the call trigger event includes, when a notification indicating that the terminal status is the calling state related to the call trigger event is received, determining that the terminal status is switched to the calling state related to the call trigger event.

The computer program included in the processor 71 provided in this embodiment of the present disclosure may also be implemented as a trigger module, a call module, and a recording module. For functions implemented by the three modules, reference may be made to the foregoing embodiment, and details are not described herein again.

In conclusion, according to the terminal and the recording method that are provided in the embodiments of the present disclosure, if a call is performed with the terminal and recording is needed, a recording operation is automatically initiated according to a one-off event trigger and monitoring of a terminal status, which simplifies steps of the recording operation of the terminal, improves usability of the terminal, and achieves a one-click effect of recording and calling.

It should be noted that, for ease of description, the foregoing method embodiments are described as a series of action combinations. However, persons skilled in the art should understand that the present disclosure is not limited to the described sequence of the actions, because some steps may be performed in another sequence or performed at the same time according to the present disclosure. In addition, persons skilled in the art should also understand that all the embodiments described in this specification belong to exemplary embodiments, and the involved actions and modules are not necessarily mandatory to the present disclosure.

In the foregoing embodiments, the description of each embodiment has respective focuses. For a part that is not described in detail in an embodiment, reference may be made to related descriptions in other embodiments.

With descriptions of the foregoing embodiments, persons skilled in the art may clearly understand that the present disclosure may be implemented by hardware, firmware or a combination thereof. When the present disclosure is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation. The computer-readable medium may include a random access memory (RAM), a read-only memory (ROM), an electrically erasable programmable read-only memory (EEPROM), a compact disc read-only memory (CD-ROM), or another optical disc storage or a disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in definition of a medium to which they belong. For example, a disk and disc used by the present disclosure includes a compact disc (CD), a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

In summary, what is described above is merely exemplary embodiments of the technical solutions of the present disclosure, but is not intended to limit the protection scope of the present disclosure. Any modification, equivalent replacement, or improvement made without departing from the spirit and principle of the present disclosure shall fall within the protection scope of the present disclosure.

What is claimed is:

1. A recording method of a terminal, comprising:
listening to a call trigger event, wherein the call trigger event is used to indicate either a calling and recording situation, and an answering and recording situation;
starting control on switching of a terminal status when the call trigger event is found, wherein the terminal status comprises a calling state related to the call trigger event, and the calling state indicates that a current call is in progress; and
initiating a recording operation to start recording of the current call when the terminal status is switched to the calling state related to the call trigger event.

2. The recording method of the terminal according to claim 1, wherein when the terminal status is switched to the calling state related to the call trigger event, the method further comprises:
periodically detecting the terminal status; and
determining that the terminal status is switched to the calling state related to the call trigger event when it is detected for a first time that the terminal status is the calling state related to the call trigger event.

3. The recording method of the terminal according to claim 1, wherein when the terminal status is switched to the calling state related to the call trigger event, the method further comprises determining that the terminal status is switched to the calling state related to the call trigger event when a notification indicating that the terminal status is the calling state related to the call trigger event is received.

4. A terminal, comprising:
a memory storing computer readable program; and
one or more processors coupled to the memory and configured to:
monitor a call trigger event;
trigger a call unit to switch a terminal status when the call trigger event is detected, wherein the terminal status comprises a calling state related to the call trigger event, the calling state indicates that a current call is in progress, and the call trigger event is used to indicate either a calling and recording situation, and an answering and recording situation;
control switching of the terminal status; and
initiate a recording operation to start recording of the current call when the terminal status controlled by the call unit is switched to the calling state related to the call trigger event.

5. The terminal according to claim 4, wherein the one or more processors is configured to:
detect, periodically, the terminal status controlled by the call unit; and
initiate the recording operation when detecting that the terminal status is the calling state related to the call trigger event.

6. The terminal according to claim 4, wherein the one or more processors is configured to learn that the terminal status is the calling state related to the call trigger event by at least one of:
starting to detect the terminal status when the call trigger event is found;
receiving information that is sent by the call unit and that is used to indicate that the terminal status is the calling state related to the call trigger event; and
trigger a recording unit to initiate the recording operation when learning that the terminal status is the calling state related to the call trigger event.

7. The terminal according to claim 4, wherein the one or more processors is further configured to:
acquire an identifier of a peer end of the current call;
create a recording file with a character string comprising the identifier as a file name; and
record content of the current call in the recording file.
